(19) United States
(12) Patent Application Publication
(10) Pub. No.: US 2007/0096731 A1
(43) Pub. Date: May 3, 2007

(54) Open-Shape Noise-Resilient Multi-Frequency Sensors

(75) Inventors: Alexey S. Peshkovsky, New York, NY (US); Daniel J. Pusiol, Alta Gracia (AR)

Correspondence Address: BOND, SCHOENECK & KING, PLLC, ONE LINCOLN CENTER, SYRACUSE, NY, 13202-1355, US

(73) Assignees: RF SENSORS, LLC, New York, NY (US); SPINLOCK, SRL, (AR)

(21) Appl. No.: 11/556,289

(22) Filed: Nov. 3, 2006

Related U.S. Application Data
(60) Provisional application No. 60/733,286, filed on Nov. 3, 2005.
(60) Provisional application No. 60/766,749, filed on Feb. 9, 2006.

(51) Int. Cl. G01V 3/00

(52) U.S. Cl. 324/300

(57) ABSTRACT

A series of open-shape nuclear quadrupole resonance (NQR) sensors having environmental noise resilience and a capability for simultaneous independent multi-frequency operation is disclosed. The sensors are multimodal birdcage or TEM-type structures made from single-turn or multi-turn interconnected windows or magnetically coupled elements having uniform distributions of the amplitudes of the corresponding radiofrequency magnetic fields along their surfaces. The phases of these fields change in a cyclical fashion, such that the interference signals are picked up with opposite phases by different parts of the sensors and are, therefore, cancelled out. The devices may have a planar or a curved shape and may or may not be shielded on one side. Planar unshielded sensors may be used to simultaneously detect signals from objects positioned on both of their sides.

### CROSS-REFERENCE TO RELATED APPLICATION

This application claims priority to U.S. Provisional Patent Application Ser. No. 60/733,286, filed on Nov. 3, 2005, and U.S. Provisional Patent Application Ser. No. 60/766,749, filed on Feb. 9, 2005.

### BACKGROUND OF THE INVENTION

1. Field of the Invention

The present invention relates to sensors for the identification of substances and, more particularly, a system and method using nuclear quadrupole resonance under conditions of environmental interference for the simultaneous identification of one or more illicit substances, such as narcotics or explosives, which may be hidden on or inside a human body or personal belongings.

2. Description of the Related Art

Security technology for controlling the traffic of illicit substances is rapidly growing in demand. Nuclear Quadrupole Resonance (NQR)-based screening systems have been proven to provide reliable and noninvasive identification of materials containing the so-called quadrupolar nuclei, such as ¹⁴N or ^{35,37}Cl, which are present in most explosives and in many of the narcotics. This methodology is not harmful to individuals or the scanned objects, and permits remote detection without the need for palpation or any mechanical contact. Additionally, automatic operation of the scanners is possible, making this technology much less dependent on a human error. The principles and the instrumentation used in NQR are, generally, similar to those employed in Nuclear Magnetic Resonance (NMR), which is a powerful and well developed technique for the investigations of solid and liquid materials, as well as for medical imaging (in the form commonly referred to as Magnetic Resonance Imaging or MRI). Both methods employ on-resonance radiofrequency (RF) magnetic field pulses (B₁ field pulses) to excite transitions between the energy levels of the detected nuclei, by way of interacting with their intrinsic magnetic moments. This excitation is followed by a relaxation process, during which the nuclei emit a response RF signal that can be detected by the same or a different sensor that was utilized for the excitation. The frequency of this signal is, generally, specific to the local environment of the nucleus, and can be used to study molecular structure or to betray the presence of a certain type of a molecule in a sample.

There are some important differences between NQR and NMR, the most significant of which relates to the manner in which the energy levels are initially established. In NMR the nuclei possessing nonzero magnetic moments become polarized by an externally established static magnetic field, B₀, whose magnitude mainly determines the resonance frequency at which the signals coming from the nuclei will oscillate. Stronger B₀ fields lead to a greater extent of nuclear polarization and, therefore, to increased sensitivity of the measurements. In NQR, on the other and, an external magnet is not required because the nuclear levels are established due to coupling between the electric quadrupole moments of nuclei, eQ, and the electric field gradients, eq, internally generated by the charge distributions in the local molecular environments. Nuclei with nonzero electric quadrupole moment (non-spherically symmetrical electric charge distribution) are those with spin I>½, which includes such common nuclei as ¹⁴N and ^{35,37}Cl. Although this interaction is purely electric in nature, since the nuclei also possess magnetic dipole moments, it is possible to induce transitions between the nuclear levels with B₁ fields and detect the signals produced by the nuclei in response, much like in NMR. At the same time, no application of an external static magnetic field is required, which is why NQR spectroscopy is frequently referred to as “NMR at zero field”.

The Hamiltonian describing the quadrupole interaction in the principal axes frame of the electric field gradient is given in terms of the nuclear spin operators, I, Iₓ, I_{y} and I_{z}, as follows:

$${H}_{Q} = \frac{{ⅇ}^{2} Qq}{4 I ( 2 I - 1 )} [ ( {I}_{z}^{2} - I ) + η ( {I}_{x}^{2} - {I}_{y}^{2} ) ] \qquad ( 1 )$$

where the quantity e²Qq is defined as the quadrupole coupling constant of a nucleus in its environment, and η describes the asymmetry of the electric field gradient. The nuclear properties are represented by the quantity eQ and the influence of the electrostatic environment is described by η and eq. For the spin I=1 ¹⁴N nucleus the three quadrupole eigenstates in terms of eigenstates of the I_{z} operator, |1>,|0> and |−1>, are |+>=(|1>+|−1>)/\sqrt{2}|−>=(|1>−|−1>)/\sqrt{2} and |0>. The transition frequencies are given by:

$$\begin{matrix}{υ}_{\pm } = \frac{{ⅇ}^{2} Qq}{4 h} ( 3 \pm η ) \\ {υ}_{0} = {υ}_{+} - {υ}_{-} \\ = \frac{{ⅇ}^{2} Qq η}{2 h}\end{matrix} \qquad ( 2 )$$

The NQR spectrum of a compound in which ¹⁴N nuclei experience non-axially symmetric electric field gradients (η≠0) will, therefore, consist of a doublet corresponding to the υ₊ and υ₋ transitions and a line at a much lower frequency corresponding to υ₀. The intensity of the transition at υ₊ is at its maximum when the RF field is applied in the X direction of the principal axes frame for the electric field gradient tensor, and the intensity of the υ₋ transition is maximized when the B₁ field lies in the Y direction. For a powder sample, a B₁ field applied in the laboratory frame will be experienced by each crystallite in a different direction in its principal axes frame, with all directions being equally probable.

As a result the effect of the B₁ field applied to an isotropic powder sample in every laboratory frame direction will appear the same, in the sense that the generated signal will have similar properties, although it will be originating from different crystallites in the sample. Since explosives or narcotics are isotropic substances, the direction of the B₁ field used for their identification is unimportant, the only relevant measure being its amplitude.

The frequencies of the NQR measurements are, generally, on the order of several MHz, much lower then those of NMR or MRI, which are on the order of several tens or hundreds of MHz. The sensitivity of the measurements is also much lower. There is, however, an important advantage of not having to place objects in strong external magnetic fields, which led to a tremendous interest in this technology in the field of illicit substance detection, where accurate, noninvasive and remote identification of materials is necessary, but the use of the external magnetic fields is undesirable, as it can damage the magnetic parts of the studied objects and endanger the people in the vicinity. Additionally, the NQR signals exhibit very high specificity to the molecules being observed, thereby providing very reliable material identification, unlike NMR, which is more suitable for structure investigations.

Various sensor designs are currently used in conjunction with the NQR scanners. Cylindrical or rectangular close-shaped RF coils may be used (solenoid, single-turn, multiple loop, etc.) for the screening of such objects as luggage or mail, which can be put through the internal volume of the sensors. These coils offer uniform B₁ fields and can be easily shielded from the RF environmental interference by placing an RF shield around the entire sensor (the coil with the screened items contained inside). There are, however, many situations when it is impossible or undesirable to place the studied objects inside a restricted volume, such as during the scanning of a minefield or of a human subject. In this case, surface devices may be used (single turn, spiral, planar solenoid, etc.). While these devices offer greater accessibility, they suffer from the environmental radiofrequency interference, coming from far away sources, such as commercial radio stations, or from the presence of other equipment in the vicinity, such as computers, switching power supplies, etc.

One design aimed at introducing environmental interference rejection properties into the surface sensors uses gradiometer coils that are immune to the environmental noise by being sensitive only to a spatial derivative of the electromagnetic field. Noise coming from a distant source can be assumed linear in space (wavelengths are much larger than the size of the coil) and, therefore, is not detected. These coils can be made, for example, by forming two electrically connected loops, one above the other, that are wound in the opposite direction. The noise from a distant source induces equal and opposite currents in the loops, canceling itself out. The sample is placed closer to one loop than to the other, and produces a stronger current in one of them than in the other. It is, therefore, detected by the coil assembly.

Another system uses two separate planar solenoid coils wound in an opposite sense and connected in series or in parallel or driven by a common circuit that couples them together and to a transmitter or receiver. The coils are positioned one above the other or side by side. Alternatively, the coils are wound in the same sense, but a phase inversion is performed in one of them before the signals from both are combined at the receiver. Noise coming from a distant source is picked up by the two coils and arrives at the receiver as two signals with opposite phases, leading to its self-cancellation. This coil assembly, therefore, possesses the property of common mode rejection. The sample is always placed closer to one coil than to the other, and its signal is, therefore, not self-cancelled. The approach of having a dedicated interference detector to be half of the sensor assembly has a general disadvantage of reducing the coil filling factor, η, by half, which leads to a reduction in the SNR, since it is proportional to \sqrt{η}.

It has been proposed that the simultaneous detection of two samples may be realized if each of them is placed within the active volumes of each of the two coils comprising a sensor assembly similar those described above. For example, a two-coil detector may be used for the control of forbidden substances hidden in shoes. The coils are constructed such that the distant source noise signals are attenuated due to their being detected equally by each coil, followed by a phase inversion in one of the coils, leading to self-cancellation upon summation at the receiver. Both coils are involved in sample excitation performed with opposite phases in the two coils. The sample signals are, therefore, also detected with opposite phases, after which one of them undergoes a phase inversion, leading to their constructive interference at the receiver. This approach, however, assumes some prior knowledge of the possible illicit substance location, and provides no detection capability outside of this region (in the region between the coils, for example).

NQR active materials normally exhibit multiple resonance lines at a range of frequencies. Simultaneous detection at more than one frequency can be utilized to make the detection very specific, drastically decreasing the possibility of false-positive alarms. Additionally, a sensor with multi-frequency capability could be used for simultaneous detection of various target substances, which is an important practical necessity. The measurements performed with different frequency channels of such sensor need to be independent, and, therefore, the channels have to possess a high degree of isolation (−20 dB is usually sufficient). Common multi-tuned coils, such as surface of solenoid coils, generally rely on the difference in frequency between the channels as a source of this isolation, and, consequentially suffer from the inability to have close frequency positioning, that may be required. Geometric decoupling is proposed as a means to alleviate this issue, utilizing surface coils with mutually perpendicular B₁ fields. This approach, however, requires complex shaping of the sensors, restricting their applicability. Additionally, only three such universally decoupled cannels are possible, while any additional resonance frequencies are attained by multi-tuning the individual coils, which makes these frequencies susceptible to the abovementioned limitation.

It is well known that the transmission efficiency and sensitivity of the radiofrequency sensors is inversely proportional to the square root of their active volumes and directly proportional to their filling factors, η. When a sensor is used for scanning of electrically conducting objects, such as a human body, restricting the active volume leads to an increase in the the quality factor (Q), providing a further increase in the SNR, which is proportional to Q^{1/2}. The active volume of a coil can be controlled by adjusting the penetration depth of the B₁ field that it generates, and, therefore, that it is able to detect, according to the principle of reciprocity. The coil's η can be adjusted by choosing a shape most suitable for the object being scanned.

It is also becoming increasingly important to be able to rapidly and accurately determine the presence of illicit substances, such as explosives or drugs, which may be concealed and transported not only in the personal belongings of travelers, but also in the garments or even inside their bodies. Increasing security threats start to demand such measures as installation of checkpoints at the entrances to public transportation systems, buildings, stadiums, public events, etc. Inspection of a human body, however, is a very challenging task, since many of the bulk detection methods commonly utilized in baggage screening, for example, X-ray absorption-based systems, are inapplicable due to their harmful side effects on the health of those being screened. Body imaging methods, for example, X-ray diffraction-based, involve much lower amounts of harmful radiation, but require extensive image interpretation efforts by specially trained personnel and cannot check for the objects hidden inside a body. Additionally, since these imaging methods reveal the body's surface along with the hidden objects, they have raised privacy-related concerns.

### BRIEF SUMMARY OF THE INVENTION

It is therefore a principal object and advantage of the present invention to provide a system and method for detecting illicit substances in the presence of environmental noise.

It is an additional object and advantage of the present invention to provide a system and method for detecting illicit substances that does not require prior knowledge of the possible locations of target substances.

It is a further object and advantage of the present invention to provide a system and method for detecting illicit substances that has multiple, well isolated (orthogonal) channels, useful at different frequencies simultaneously and independently without requiring complicated sensor shapes.

It is another object and advantage of the present invention to provide a system and method for detecting illicit substances that can select the penetration depth of the B₁ field so that the active volume, filling factor, and quality factor may be optimized for maximal efficiency and sensitivity.

It is yet a further object and advantage of the present invention to provide a system and method for detecting illicit substances that is capable of being adapted to closely match the shape of the object to be scanned.

It is yet an additional object and advantage of the present invention to provide a walk-through checkpoint system suitable for the reliable and rapid human body scanning.

In accordance with the foregoing objects and advantages, the present invention provides a system and method using the noise-resilient resonant modes of open-shape, multi-element sensors for nuclear quadrupole resonance detection of target materials. The embodiments of the present invention comprise designs and techniques for designing sensors for the NQR detection of a wide range of illicit substances, such as explosives or narcotics, or to any other NQR application, such as industrial process monitoring, that is carried out in the presence of environmental interference and/or in the situations where open-shape devices are preferred. The embodiments of the present invention further comprise a methodology and design criteria for the construction of the surface or open-volume sensors possessing properties such as noise-rejection, horizontally uniform B₁ field magnitude (no blind spots along the surface), capacity for simultaneous multi-frequency operation, penetration depth control and shape adaptability, which are the characteristics identified as necessary in the previous section. The embodiments of the present invention can be utilized with any NQR spectrometer system capable of producing RF pulses of appropriate power and frequency, and of receiving the NQR signals. The embodiments of the present invention are, however, preferably used with a multi-channel system capable of delivering RF pulses and acquiring signals at different frequencies simultaneously and independently through its different channels.

The present invention comprises various sensor types, such as planar, half-cylindrical open-volume birdcage, or transverse electromagnetic (TEM) coils, that are designed specifically for use in NQR-based applications in order to provide the necessary parameters for the detection of illicit substances in environmental noise and permit their use in low-frequency NQR application. The designs of the sensors of the present invention are based on the general principles of conventional open birdcage and the open TEM coil designs. More specifically, the embodiments of the current invention are based on an 8-window open-shape birdcage coil design and on a 9-element open-shape TEM coil design. Both designs have 9 legs carrying the current, responsible for the generation and the reception of the B₁ fields in the sensor's working area. An open birdcage or TEM coil can be viewed as a half-wave resonator where a standing wave is formed in the direction perpendicular to the coil's legs. The current amplitudes in the legs are modulated sinusoidally going from one leg to the next, such that an integer number of half-periods fit between the first and the last leg. Modes are formed at different frequencies according to the number of the half-periods. In the current document, we will refer to the modes by the number of the formed half-periods. The correspondence between the frequencies and the mode's number depends on the type of the coil and is, for example, not the same in a high-pass or a low-pass birdcage coil. It is, however, important to point out that any of the modes may be excited independently from the others, and that it is possible to separately adjust the frequencies of the B₁ fields generated and detected by these modes.

In another embodiment, the present invention comprises a NQR checkpoint inspection system that permits identification of substances hidden on or inside a human body as well as other objects, such as carry-on items. The spectrometer part of the system comprises a single or a plurality of scanning channels, depending on a single or a plurality of prohibited substances to be screened and/or a single or a plurality of localizations of the contraband substances on or in the human body to be scanned. Each individual detection channel includes a transmitter for generating and amplifying a resonant frequency to be delivered to the scanned objects, a transmit/receive switch, a preamplifier and a receiver for the NQR signal detection. A sensor with one or multiple channels is utilized in conjunction with the spectrometer and is connected to it through a matching network. Instead of one such sensor, a decoupled array of multiple sensors may be used, providing some important advantages, as mentioned below. The side of the structure opposite to the entrance is capable of separating into two door-like parts, permitting a convenient exit for the persons upon opening. The sensor that is incorporated into the structure is based on the TEM-type half-cylindrical coil, which has a multi-channel capability, a uniform radiofrequency field amplitude distribution along its surface and is composed of elements that are coupled to each other only by virtue of their radiofrequency magnetic fields, without any electrical connections being necessary. Therefore, opening and closing of the sensor structure does not require interrupting and reforming any such connections, which, otherwise, would lead to their oxidation or other type of degradation, and would decrease the sensor's performance.

### BRIEF DESCRIPTION OF THE DRAWINGS

The present invention will be more fully understood and appreciated by reading the following Detailed Description in conjunction with the accompanying drawings, in which:

FIG. 1 is a schematic showing the arrangement of conductors and capacitors in prior art birdcage coils (only two windows of each type of coil are shown to illustrate the interconnection pattern).

FIG. 2 is a schematic showing the arrangement of conductors and capacitors in a dual-turn embodiment of the high-inductance birdcage coils for low-frequency NQR according to the present invention (only two windows are shown to illustrate the interconnection pattern).

FIG. 3 is a schematic showing the arrangement of conductors and capacitors in the elements of prior art TEM coils (only three elements are shown to illustrate the layout permitting the inductive coupling necessary for operation).

FIG. 4 is a schematic showing another embodiment of the present invention including dual-turn elements for the construction of high-inductance TEM coils for low-frequency NQR (only three elements are shown to illustrate the layout permitting the inductive coupling necessary for operation).

FIG. 5a and 5b are schematics showing the preferred shapes for planar and half-cylindrical open-shape birdcage sensors according to the present invention.

FIG. 6a and 6b are schematics showing the preferred shapes for planar and half-cylindrical open-shape TEM sensors according to the present invention.

FIG. 7 is a schematic of the current distribution patterns in the legs of the preferred embodiments of the open-shape sensors according to the present invention for the surface mode, butterfly mode, mode 3, and mode 4 corresponding to different frequencies of the coil's operation.

FIGS. 8a through 8h is a schematic of the current distributions in the legs of the preferred embodiments of the open-shape sensors according to the present invention corresponding to the surface mode up to the fourth mode, as well as the B₁ field patterns.

FIGS. 9a through 9c is a schematic of the B₁ field patterns for the butterfly, third, and fourth modes on both sides of a planar sensor according to the present invention when no shield is utilized.

FIGS. 10a and 10b is a shows an inductive (a) and a capacitive (b) method of simultaneously driving the third and the fourth modes of a planar embodiment of an open-shape sensor accordingly to present invention useful for the simultaneous dual-frequency operation.

FIG. 11 is a schematic of a stacked sensor array comprised of three curved-shaped TEM sensors.

FIG. 12 is a perspective view of a preferred embodiment of a walk-through inspection system according to the present invention.

FIG. 13 is a schematic of the manner in which a person may enter and exit a walk-through inspection system according to the present invention.

### DETAILED DESCRIPTION OF THE INVENTION

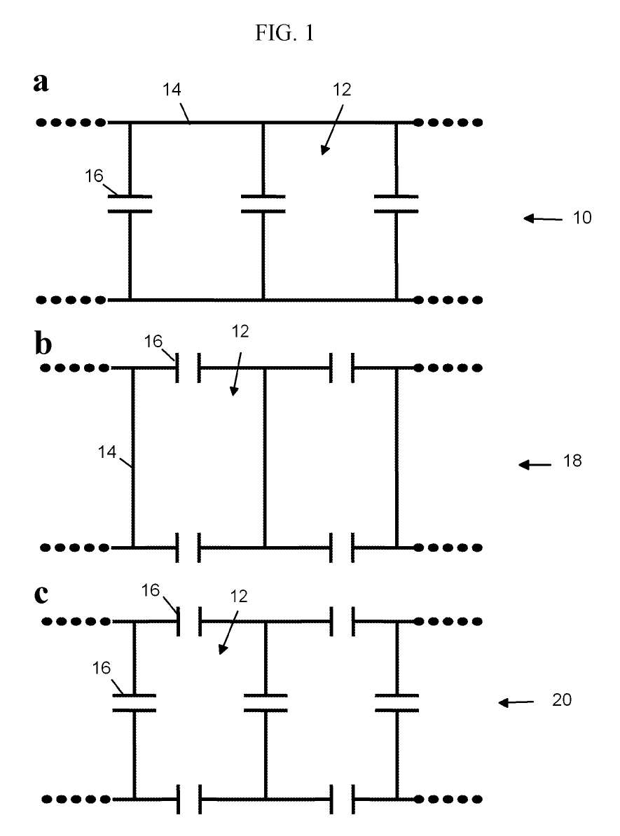

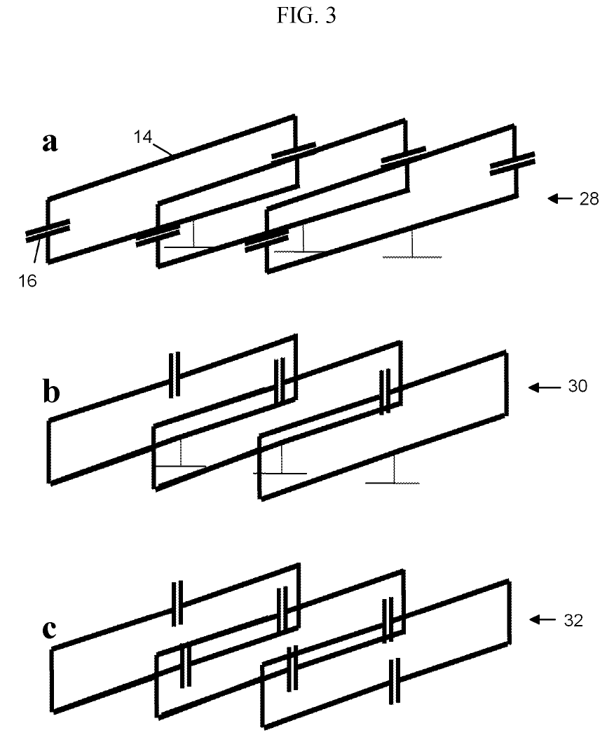

Referring now to the drawings, wherein like reference numerals refer to like parts throughout, there is seen in FIG. 1 the various possible arrangements of conductors and capacitors in the interconnected windows of the birdcage coils according to the present invention, and there is seen in FIG. 3 the basic inductively coupled elements with incorporated capacitors for TEM coils according to the present invention.

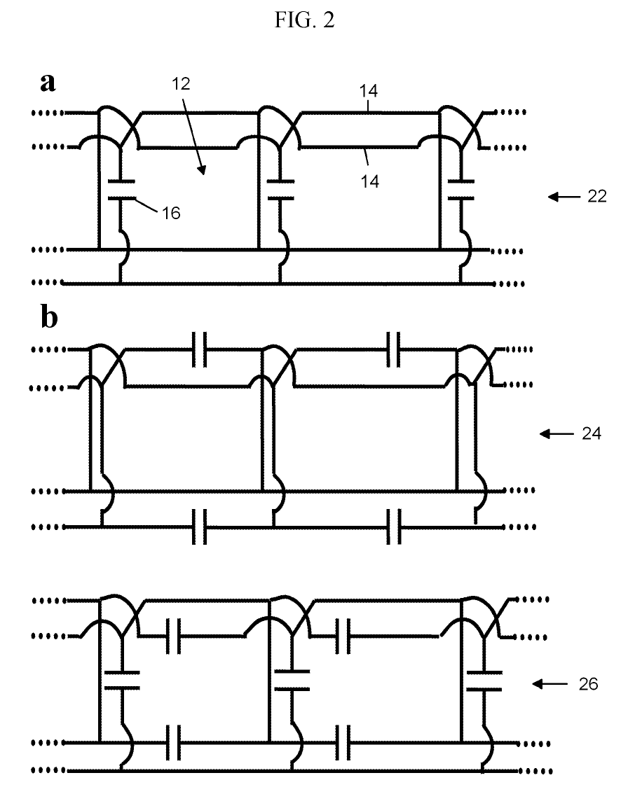

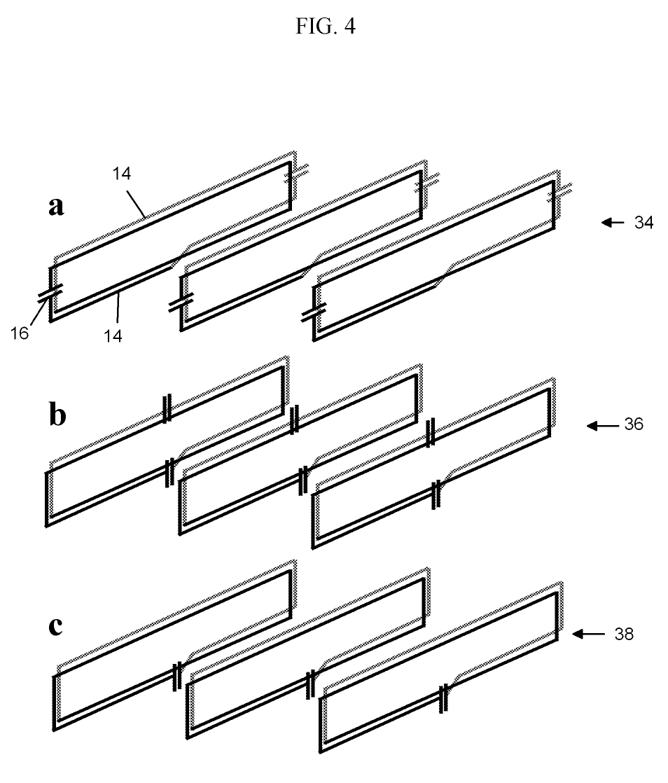

More specifically, there is seen in FIG. 1a a low pass birdcage coil 10 comprising a series of windows 12 formed by conductors 14 and capacitors 16. FIG. 1b depicts a high pass birdcage coil 18 having a series of windows 12 formed by conductors 14 and capacitors 16. Finally, FIG. 1c depicts a hybrid coil 20 having a series of windows 12 formed by capacitors 16. FIG. 2a through 2c depicts the various double turn birdcage coils 22, 24, and 26 (i.e., low pass, high pass, and hybrid) corresponding to single turn birdcage coils 10, 18, and 20. The corresponding varieties of single turn TEM coil elements 28, 30, and 32 are seen in FIG. 3a though 3c, and the corresponding varieties of double turn TEM coil elements, 34, 36, and 38, are seen in FIGS. 4a through 4c.

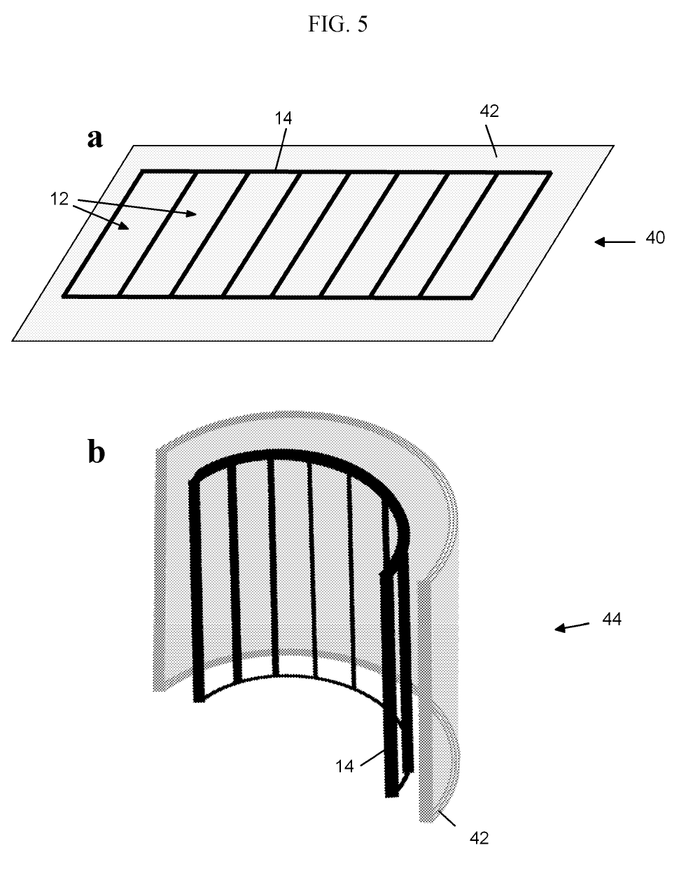

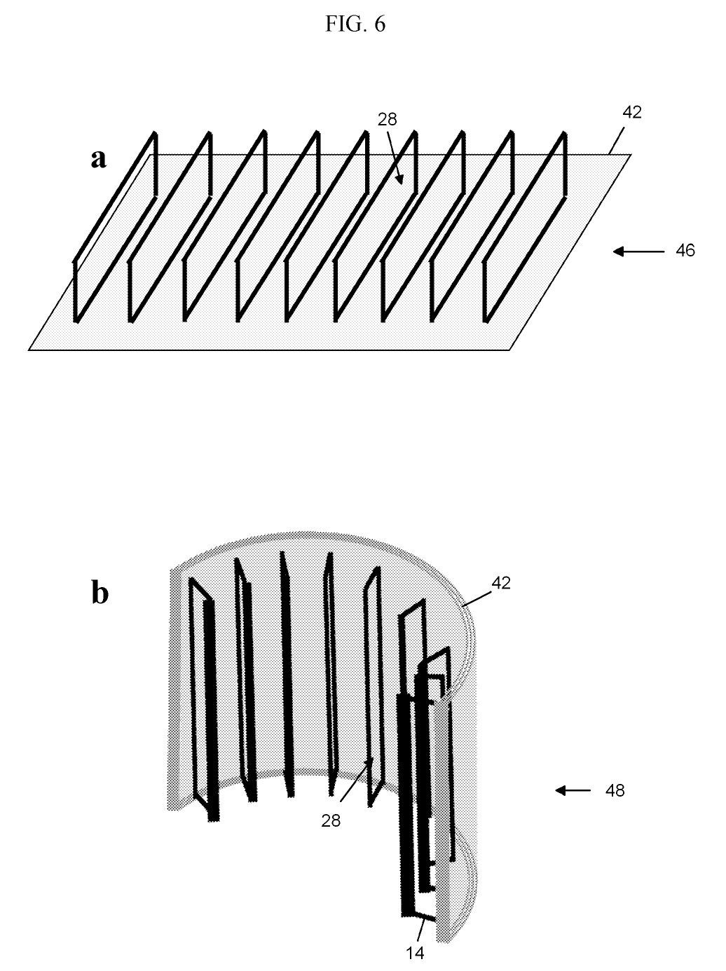

There is seen in FIG. 5a an open planar birdcage sensor 40 comprising a series of windows 12 formed by conductors 14 positioned proximately to a shield 42 (capacitors 16 are not shown for simplicity). FIG. 5b depicts an open half-cylindrical birdcage sensor 44 comprising a series of windows 12 formed by conductors 14 positioned proximately to shield 42. There is seen in FIG. 6a an open planar TEM sensor 46 comprising a series of TEM elements 28 positioned proximately to shield 42. FIG. 6b depicts an open half-cylindrical TEM sensor 48 comprising a series of TEM elements 28 positioned proximately to shield 42. It is important to point out that while similar layouts may be used in some embodiments of the present invention, their operation principles are different, and relate to the use of the higher order modes than those used in the prior art. The details are provided in the section dedicated to the description of the preferred embodiments of the invention.

Since most NQR measurements are performed at low frequencies (below a few MHz), the standard birdcage and TEM designs may present some serious disadvantages due to their associated low inductances that require the use of the unreasonably large capacitance values to achieve low-frequency resonance conditions. Some of the embodiments of the current invention are, therefore, preferably constructed with high-inductance windows or elements, introduced as a part of the current invention for the birdcage coils (shown in FIG. 2) and for the TEM coils (shown in FIG. 4). The use of the dual-turn design increases the inductance of each window or element, and, therefore, of the coils themselves, by a factor of four, compared to the conventional-design coils. This reduces the required capacitor values also by a factor of four, keeping them within reasonable range. Other numbers of turns may be used in a similar manner in cases when further increase in the inductance is desired.

The preferred embodiments of the current invention are based on an 8-window open-shape birdcage coil design and on a 9-element open-shape TEM coil design. Both designs have 9 legs carrying the current, responsible for the generation and the reception of the B₁ fields in the sensor's working area. An open birdcage or TEM coil can be viewed as a half-wave resonator where a standing wave is formed in the direction perpendicular to the coil's legs. The current amplitudes in the legs are modulated sinusoidally going from one leg to the next, such that an integer number of half-periods fit between the first and the last leg. Modes are formed at different frequencies according to the number of the half-periods. In the current document, we will refer to the modes by the number of the formed half-periods. The correspondence between the frequencies and the mode's number depends on the type of the coil and is, for example, not the same in a high-pass or a low-pass birdcage coil. It is, however, important to point out that any of the modes may be excited independently from the others, and that it is possible to separately adjust the frequencies of the B₁ fields generated and detected by these modes.

In the prior art magnetic resonance studies, the use of the B₁ fields with uniform magnitudes and phases is preferred. This requirement provides restrictions on the use of the modes available in the multi-modal sensors (only the mode 1 and the mode 2 in the region restricted to the central area of the sensor are used). NQR measurements of randomly oriented substances, such as explosives or narcotics, on the other hand, are insensitive to the direction of the B₁ fields, as shown above. Consequentially, any or all of the available modes may be utilized. As described below, the use of the higher modes provides a number of important advantages.

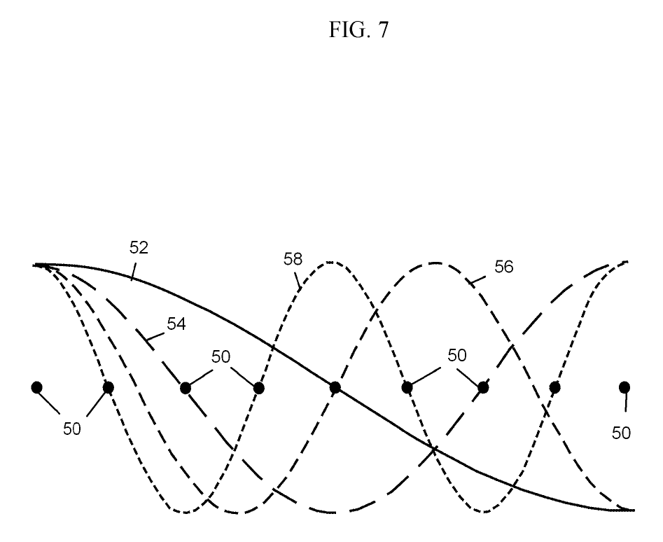

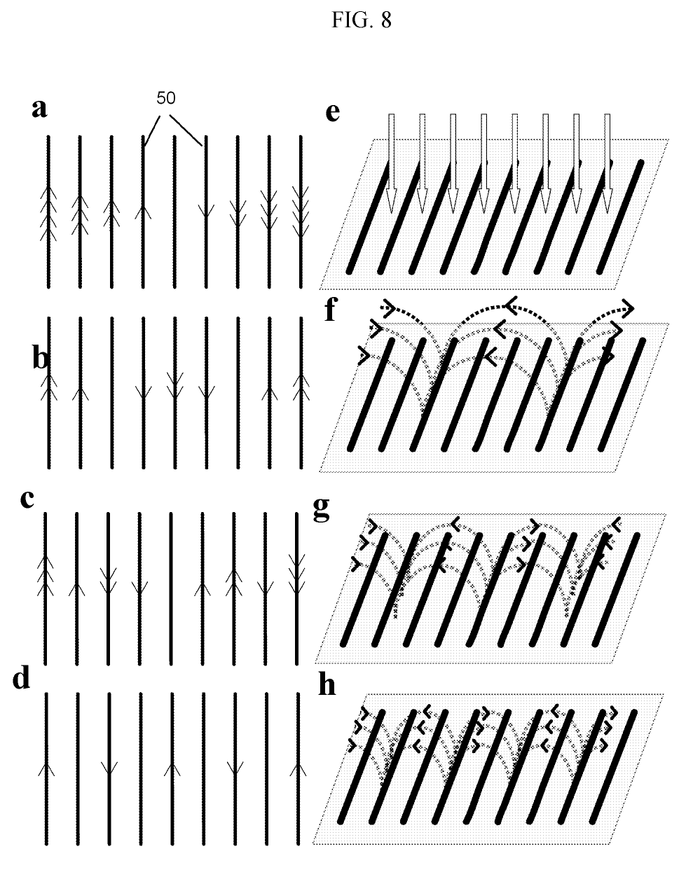

The current distributions in the legs 50 of these devices correspond to the naturally formed resonant modes, as seen in FIG. 7, for modes one 52 (surface), two 54 (butterfly), three 56, and four 58. Higher modes are not shown, but are also present and can be utilized. The current flow patterns are shown in more detail in FIG. 8, along with the corresponding B₁ field patterns for each mode. It is evident from FIG. 8e that mode 1 corresponds to the B₁ field similar to that of a surface coil and is relatively uniform in its direction and strength and is oriented outwards from the coil's surface. This mode, which is sometimes called “surface mode,” has a high degree of homogeneity and significant penetration depth. It is, however, susceptible to the common disadvantages of the surface coils, such as a strong affinity to the environmental interference. The B₁ field corresponding to mode 2, which is sometimes called the “butterfly mode,” undergoes one full phase rotation along its surface while maintaining a relatively constant magnitude, as illustrated in FIG. 8f. Consequentially, this mode possesses some environmental interference rejection properties, and its penetration depth is not as great as that of the mode 1. The noise arriving in the direction orthogonal to the surface of the coil is sensed by the left and the right sides of the coil with opposite phases and, therefore, cancels itself out. While conventional systems do not create or detect in the region of space between the coils because there is no field there, mode 2 of the sensors of the present invention possesses a field in the central part as well, where it is oriented parallel to the sensor's surface. Detection of the target objects can, therefore, be made anywhere along the sensor's surface. The cancellation of the noise arriving from the direction parallel to the coil's surface and orthogonal to its legs depends of the nature of the signal.

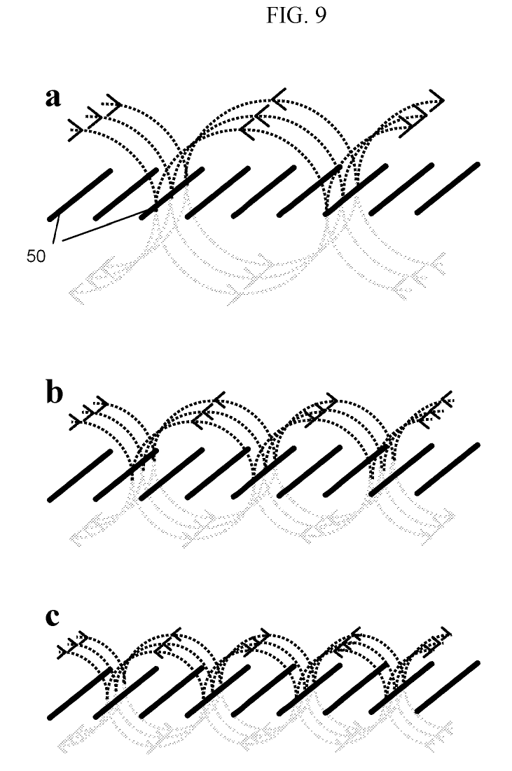

Homogeneous interference signals coming from distant sources will be better attenuated than those arriving from the more near sources. This is due to the fact that the noise rejection properties rely on the fact that the phase of the B₁ field is rotated by one full cycle along the sensor's surface, and if the noise source can be considered to be closer to one side of the sensor than the other, cancellation will not be complete. Noise rejection properties of this mode are expected to be improved in the double-sided embodiment of the sensor, as shown in FIG. 9a. The higher modes, exemplified in FIG. 8g and 8h showing the B₁ field patterns for the modes three and four, possess further improved noise rejection properties not only for the vertical, but also for the horizontal components of the environmental interference, since both components of the B₁ fields corresponding to these modes become inverted more than once in both dimensions across the surface area of the sensor. Rejection of the noise coming from both the distant as well as more nearby sources is, therefore, obtained. This pattern is continued for the higher modes, with the increased number of the B₁ inversions, the improving noise cancellation properties and the diminishing depth of the field's penetration into the space away from the sensor's surface. All modes are orthogonal to each other and may, therefore, be utilized simultaneously.

Accordingly, sensors possessing the described modes with numbers higher then one are noise-resilient, do not have any blind spots along their surfaces, capable of multi-frequency operation via independent channels, have selectivity over the penetration depths of the associated fields (by mode selection) and have adaptable shapes (planar or curved sensors may be used). These sensors, thereby, satisfy all of the requirements identified above.

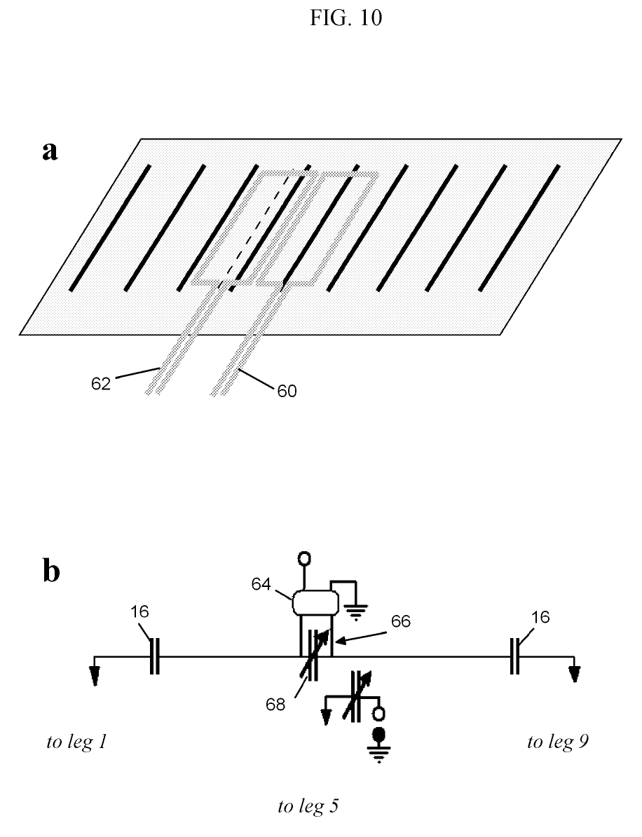

The first preferred embodiment of the current invention is a planar shielded 8-window birdcage-type sensor, as seen in FIG. 5a. The types of the windows used to construct this sensor can be those described in the FIG. 1 or in FIG. 2. Modes 3 and 4 described in FIG. 8c-d and 8g-h are preferably used to achieve an independent dual-frequency operation and noise rejection properties. The driving of the modes may be performed by the use of inductive loops 60 and 62, as seen in FIG. 10a (centrally positioned loop 60 serves to excite the mode 3 and offset loop 62 shown on the left excites the mode 4), capacitively, as shown in FIG. 10b (the connections to the legs one and nine excite mode 3 and the connection to the central leg drives mode 4), or by any combination of the above. The active volume of the sensors is thus selectable by selecting the appropriate mode. More specifically, there is seen in FIG. 10b a balancing unit 64 and a matching network 66 including an adjustable capacitor 68 interconnected to legs one and nine via capacitors 16. For driving mode four, matching network 66 (without balancing unit 64) is interconnected to leg five. Isolation of better than 25 dB between the channels is achieved by this arrangement. It should be recognized by those of skill in the art that conventional tuning networks for independently adjusting the frequency of each mode may be included. Alternatively, shield 42 may be positioned to adjust operation of the sensors of the present invention.

The second preferred embodiment of the current invention is a planar unshielded 8-window birdcage-type sensor, similar to that seen in FIG. 5a, but without the shield. Simultaneous detection of the materials positioned on either or both sides of the sensor can be carried out. The types of the elements used to construct this sensor can be those described in the FIG. 1 or in FIG. 2. The modes 3 and 4, whose field patterns are shown in FIG. 9b and FIG. 9c are preferably used to achieve a dual-sided independent dual-frequency operation and noise rejection properties. The driving of the modes is achieved in a manner similar to that of the first embodiment.

The third preferred embodiment of the current invention is an open half-cylindrical shielded 8-window birdcage-type sensor, shown in FIG. 5b. The types of the elements used to construct this sensor can be those described in the FIG. 1 or in FIG. 2. The modes 3 and 4, whose field patterns are shown in FIG. 8c-d and 8g-h are preferably used to achieve an independent dual-frequency operation and noise rejection properties. The driving of the modes is achieved in a manner similar to that of the first embodiment. A filling factor increase and some additional noise rejection properties are achieved due to the curved shape of this embodiment, which provides some shielding from the noise arriving in the lateral direction.

The fourth preferred embodiment of the current invention is a planar shielded 9-element TEM-type sensor seen in FIG. 6a. The types of the elements used to construct this sensor can be those described in the FIG. 3 or in FIG. 4. The modes 3 and 4 described in FIG. 8c-d and 8g-h are preferably used to achieve an independent dual-frequency operation and noise rejection properties. The driving of the modes is achieved in a manner similar to that of the first embodiment.

The fifth preferred embodiment of the current invention is a planar unshielded 8-window TEM-type sensor, similar to that seen in FIG. 6a, but without the shield. Simultaneous detection of the materials positioned on either or both sides of the sensor can be carried out. The types of the elements used to construct this sensor can be those described in the FIG. 3 or in FIG. 4. The modes 3 and 4, whose field patterns are seen in FIG. 9b and 9c are preferably used to achieve a dual-sided independent dual-frequency operation and noise rejection properties. The driving of the modes is achieved in a manner similar to that of the first embodiment.

The sixth preferred embodiment of the current invention is an open half-cylindrical shielded 9-element TEM-type sensor, seen in FIG. 6b. The types of the elements used to construct this sensor can be those described in the FIG. 3 or in FIG. 4. Modes 3 and 4, whose field patterns are seen in FIG. 8c through 8d and 8g through 8h, respectively, are preferably used to achieve an independent dual-frequency operation and noise rejection properties. The driving of the modes are achieved in a manner similar to that of the first embodiment. Additional noise rejection properties are achieved due to the curved shape of this embodiment, which provides some shielding from the noise arriving in the lateral direction.

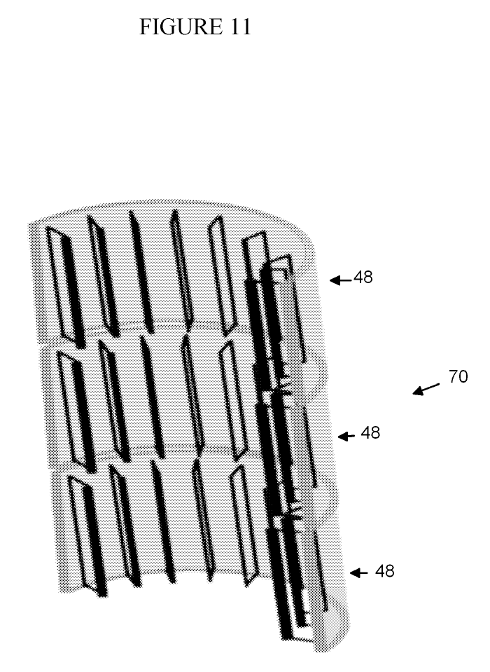

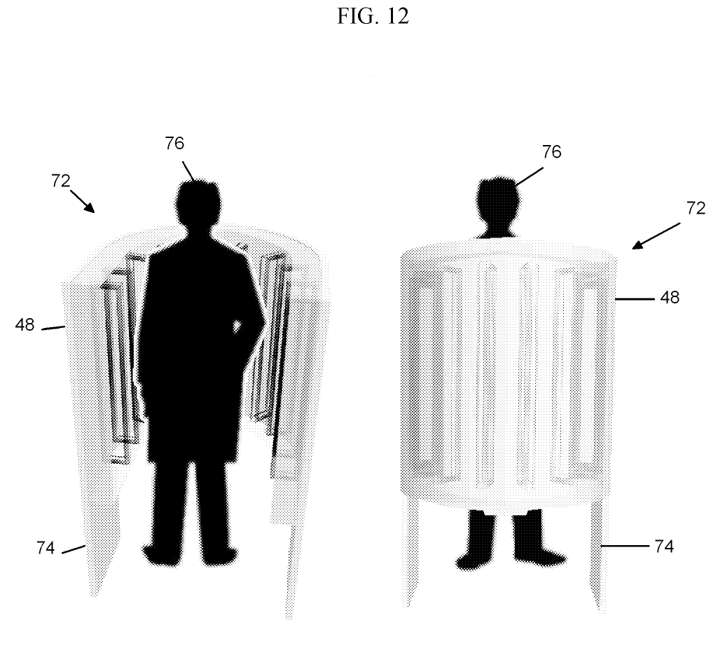

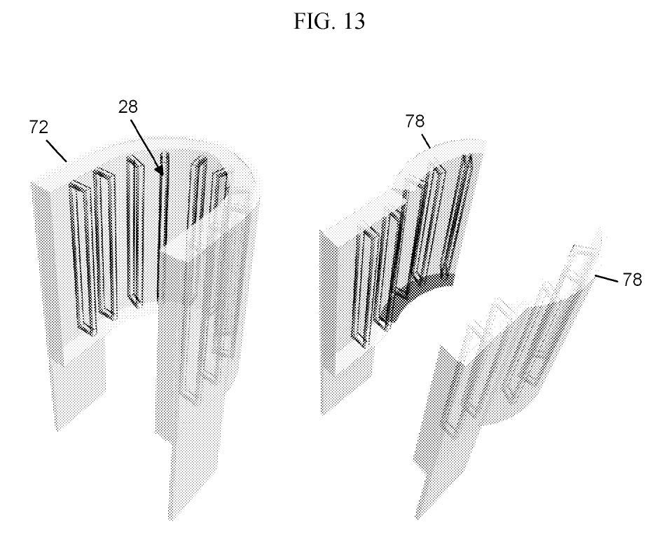

As an example of another embodiment of the present invention, there is seen in FIG. 11 a stacked array 70 of individual open half-cylindrical TEM sensors 48, such as those seen in FIG. 6b. Referring to FIG. 12, the preferred embodiment of the walk-through human body NQR inspection system 72 according to this invention comprises a sensor 48 mounted on a support structure 74 so that the potential suspect areas on the surface or the interior of a human body 76 are well within its active volume. Mechanical structure 74 provides shielding on the outside of sensor 48, is easily accessible on one side, and includes one or more barriers 78 that may be selectively opened or closed, such as the hinged doors seen in FIG. 13, to allow a scanned person to exit without having to go backwards and around the structure. Since TEM sensors 48 are composed of magnetically coupled elements, and not electrically coupled elements like conventional birdcage-type devices, TEM sensors 48 of the present invention can be opened and closed as shown in the FIG. 13 without interrupting or reforming any electrical connections. This feature permits having a high volume of traffic through inspection system 72 without wearing down the electrical parts.

In other preferred embodiments, multi-sensor arrays 70, such as that seen in FIG. 11, may be incorporated in similar structures and any number of sensors may be used in such array. Preferably, the sensors should be decoupled from each other. This can be achieved, for example, by utilizing different modes in the neighboring sensors, although, a number of alternative decoupling methods may be utilized. During the transmission phase of the scan, the sensors may be driven all together by the same transmitter, while during the signal reception phase of the scan, the signals coming from each sensor may be routed to different preamplifiers and, subsequently, receivers. This will provide the increase in the signal to noise ratio of the measurements and give the inspection system some localization properties, since the active volume of each sensor will be responsible for a specific part of the body being scanned. Alternatively, the sensors may be independently driven by separate transmitters, their operation may be sequential, or only some of the available sensors may be used. Since every sensor in the array is based on the TEM design, they all may be opened and closed together, similarly to the way described for the single sensor system. No significant changes in the support structure are, therefore, necessary.

According to the present invention, the method of inspecting for concealed substances is as follows. First, a person enters the active area inspection system 72, which has its barrier 78 closed and is ready for a scan. The presence of person 76 is either automatically detected or is registered by an operator. Any tuning and matching adjustments are automatically made, if needed. Next, single, or multiple-frequency scan is initiated, depending on the chosen settings. The results of the scan are provided to the operator in the form that does not require significant interpretation (e.g., a green/yellow/red light). In case of inconclusive scan (e.g., a yellow light), the exhaustive scanning mode is initiated. In case of positive illicit substance detection (e.g., a red light), the doors remain closed, and the appropriate action may be conducted. In case of negative illicit substance detection (e.g., a green light), barrier 78 opens, allowing person 76 to exit. Finally, barrier 78 is closed and the system is prepared to receive next person 76.

In addition to illicit substance detection, the present invention may be used for biomedical applications of NQR, such as muscle scanning. It is to be understood that various modifications in form and detail of the specific preferred embodiments referenced here may be made by those skilled in the art without departing from the scope of the present inventions.

What is claimed is:

1. A system for simultaneously detecting at least one substance of interest in the presence of environmental interference, comprising:
a sensor including a plurality of resonant modes having noise-resilient properties and lacking blind spots; and
a matching network interconnected to said sensor for the simultaneous excitation of said plurality of resonant modes while maintaining isolation between each of said plurality of resonant modes.

2. The system of claim 1, wherein said sensor comprises a multi-window, open-shape birdcage-type structure.

3. The system of claim 2, wherein said multi-window, open-shape birdcage-type structure comprises conductors and capacitors forming a series of electrically interconnected single-turn loops.

4. The system of claim 2, wherein said multi-window, open-shape birdcage-type structure comprises conductors and capacitors forming a series of electrically interconnected multi-turn loops.

5. The system of claim 1, wherein said sensor comprise a multi-element, open-shape TEM-type structure.

6. The system of claim 5, wherein said multi-element, open-shape transverse electromagnetic type structure comprises conductors and capacitors forming a series of magnetically coupled single-turn loops.

7. The system of claim 6, wherein said multi-element, open-shape transverse electromagnetic type structure comprises conductors and capacitors forming a series of magnetically coupled multi-turn loops.

8. The system of claim 1, wherein said matching network is inductively coupled to said sensor for independent driving of each of said plurality of resonant modes.

9. The system of claim 1, wherein said matching network is capacitively coupled to said sensor for independent driving of each of said plurality of resonant modes.

10. The system of claim 1, wherein said matching network is connected to said sensor by a combination of inductive and capacitive coupling for independent driving of each of said plurality of resonant modes.

11. A system for simultaneously detecting at least one substance of interest in the presence of environmental interference, comprising:
a planar sensor including a plurality of resonant modes having noise-resilient properties and lacking blind spots; and
a matching network interconnected to said sensor for the simultaneous excitation of said plurality of resonant modes while maintaining isolation between each of said plurality of resonant modes.

12. The system of claim 11, wherein said planar sensor is selected from the group consisting of single turn birdcage coils, multiple turn birdcage coils, single turn transverse electromagnetic coils, and multiple turn transverse electromagnetic coils.

13. The system of claim 12, wherein each of said plurality of modes includes an independently adjustable frequency.

14. The system of claim 11, wherein said planar sensor includes a first side and a second, opposing side and is capable of detecting said at least one substance if it is positioned on said first side or said second side.

15. The system of claim 12, further comprising a shield positioned on said first side of said planar sensor, thereby restricting detection of said at least one substance to said second opposing side.

16. A system for detecting the presence of at least one substance of interest, comprising:
a housing comprising a shield having an entrance and an exit;
a barrier connected to said housing for selectively permitting access to said exit; and
a sensor comprising at least one multi-frequency, noise-resilient transverse electromagnetic coil including a plurality of resonant modes and lacking blind spots positioned in said housing.

17. The system of claim 16, wherein said sensor comprises an array of multi-frequency, noise-resilient transverse electromagnetic coils.

18. The system of claim 17, wherein each of said coils in said array is decoupled from adjacent coils by using a different mode.

19. The system of claim 18, further comprising at least one transmitter interconnected to said sensor for simultaneously driving said coils.

20. The system of claim 19, further comprising at least one receiver interconnected to said array of sensors for receiving signals transmitted by said coils.
